(19) United States
(12) Patent Application Publication
(10) Pub. No.: US 2019/0221856 A1
(43) Pub. Date: Jul. 18, 2019

(54) Electrocatalyst for the Oxygen Reduction Reaction

(71) Applicant: Brookhaven Science Associates, LLC, Upton, NY (US)

(72) Inventors: Miomir Vukmirovic, Coram, NY (US); Radoslav R. Adzic, East Setauket, NY (US); Liang Song, Port Jefferson Station, NY (US); Zhixiu Liang, Port Jefferson Station, NY (US)

(21) Appl. No.: 16/245,623

(22) Filed: Jan. 11, 2019

Related U.S. Application Data
(60) Provisional application No. 62/616,850, filed on Jan. 12, 2018.

(51) Int. Cl. H01M 4/86; H01M 4/92

(52) U.S. Cl. CPC H01M 4/8657; H01M 4/926

(57) ABSTRACT

Electrocatalysts for use in fuel cells are claimed. The electrocatalysts include a particle core of a metal selected from W, Mo, and Re and a metal selected from Ni, Fe, and Co. A layer of Pd is adhered to the core, and a layer of catalytically active metal is adhered to the layer of Pd. A fuel cell and a method for producing electrical energy are also claimed.

### CROSS-REFERENCE TO RELATED APPLICATION

This application claims the benefit of U.S. Provisional Application No. 62/616,850, filed on Jan. 12, 2018, which is hereby incorporated by reference in its entirety.

This invention was made with Government support under contract number DE-SC0012704 awarded by the U.S. Department of Energy. The Government has certain rights in the invention.

### FIELD OF THE INVENTION

This disclosure relates generally to electrocatalysts, more specifically to electrocatalysts for use in fuel cells.

### BACKGROUND

A fuel cell is an electrochemical device capable of converting the chemical energy of a fuel and an oxidant into electrical energy. A standard fuel cell is comprised of an anode and cathode separated by a conducting electrolyte which electrically insulates the electrodes yet permits the flow of ions between them. The fuel cell operates by separating electrons and ions from the fuel at the anode and transporting the electrons through an external circuit to the cathode. The ions are concurrently transported through the electrolyte to the cathode where the oxidant is combined with the ions and electrons to form a waste product. An electrical circuit is completed by the concomitant flow of ions from the anode to cathode via the conducting electrolyte and the flow of electrons from the anode to the cathode via the external circuit.

In fuel cells, the oxygen reduction reaction (ORR) is the reaction occurring at the cathode. The ORR kinetics is very slow. In order to speed up the ORR kinetics to reach a practical usable level in a fuel cell, a cathode ORR catalyst is needed. The catalysts developed so far in acid fuel cells have a high amount of Platinum Group Metals (PGMs, iridium, osmium, palladium, platinum, rhodium, and ruthenium). However, these catalysts may not have enough activity per mass of PGM and may have less durability than desired. This, as well as the high cost, limits the broad commercialization of fuel cell cars.

### SUMMARY OF THE INVENTION

Embodiments include an electrocatalyst having a particle core of at least one metal selected from W, Mo, and Re, and at least one metal selected from Ni, Fe, and Co, a layer of Pd adhered to the core, and a layer of catalytically active metal adhered to the layer of Pd.

Embodiments include a method of making the electrocatalyst, including:
Metal precursors+surfactant (such as a block polymer) dispersed in and organic solvent such as tetrahydrofuran (THF) for about 1 to about 10 min or more
Add a super-hydride reducing agent and sonicate for 5 min—about 4 h
Removal of surfactant by thermal treatment 2 h at 250° C. in H₂
Pd displacement—wt % of Pd 9.9, Ni 2.1, and W 2.7
Pt deposition (Cu underpotential deposition (UPD))

One aspect of the invention relates to an electrocatalyst including a particle core including at least one metal selected from W, Mo, and Re, and at least one metal selected from Ni, Fe, and Co; a layer of Pd adhered to the core; and a layer of catalytically active metal adhered to the layer of Pd. In a preferred embodiment, the particle core consists of one metal selected from W, Mo, and Re and one metal selected from Ni, Fe, and Co. The ratio of one metal selected from W, Mo, and Re to one metal selected from Ni, Fe, and Co is preferably about 1:1 to about 1:2. Preferably, the particle core includes W and Ni.

The layer of Pd is preferably from about 1 to about 4 atom monolayers thick. The preferred thin layer of catalytically active metal atoms is Pt. The Pt is preferably from about 1 to about 4 atom monolayers thick. The particle core is preferably a nanoparticle having dimensions of about 1 to about 100 nm along one or more orthogonal directions, more preferably a nanoparticle having dimensions of about 2 to about 5 nm along three orthogonal directions.

In a preferred embodiment, the core includes W and Ni, and the catalytically active metal includes Pt. The particle core is preferably directly adhered to a carbon surface. Preferably, the layer of catalytically active metal adhered to the layer of Pd is not adhered in-between the particle cores and carbon surface.

Another aspect of the invention relates to a fuel cell including (i) a cathode comprised of a cathode catalyst including a particle core including at least one metal selected from the group consisting of W, Mo, and Re, and least one metal selected from the group consisting of Ni, Fe, and Co; a layer of Pd adhered to the core; and a layer of Pt adhered to the layer of Pd, wherein the particle core is directly adhered to a carbon surface; (ii) an anode; (iii) an electrically conductive contact connecting the cathode to the anode; and (iv) an ion-conducting electrolyte in contact with the cathode and the anode.

Another aspect of the invention relates to a method for producing electrical energy. The method includes (a) providing a fuel cell including: (i) a cathode comprised of a particle core including at least one metal selected from the group consisting of W, Mo, and Re, and least one metal selected from the group consisting of Ni, Fe, and Co; a layer of Pd adhered to the core; and a layer of Pt adhered to the layer of Pd, wherein the particle core is directly adhered to a carbon surface; (ii) an anode; (iii) an electrically conductive contact connecting the cathode to the anode; and (iv) an ion-conducting electrolyte in mutual contact with the cathode and the anode; (b) contacting the cathode with oxygen; and (c) contacting the anode with a fuel source.

### BRIEF DESCRIPTION OF THE DRAWINGS

FIG. 1. Is a TEM image of WNi nanoparticles.

FIG. 2 (a) Cyclic voltammetry and 2(b) ORR polarizations curves for PtML/Pd/WNi/C sample recorded after 0; 5,000; 10,000; 20,000; and 30,000 cycles of the durability test.

FIG. 3. Is PGM mass activity for PtML/Pd/WNi/C sample recorded after 0; 5,000; 10,000; 20,000; and 30,000 cycles of the durability test.

### DETAILED DESCRIPTION

Embodiments described in this disclosure include electrocatalysts that have an increased oxygen reduction reaction (ORR) activity of the reaction sites in the catalytic layer while at the same time have reduced the PGM metal loading. These electrocatalysts may be used in polymer electrolyte membrane fuel cells (PEMFC).

A proton exchange membrane fuel cell transforms the chemical energy liberated during the electrochemical reaction of hydrogen and oxygen to electrical energy, as opposed to the direct combustion of hydrogen and oxygen gases to produce thermal energy.

A stream of hydrogen is delivered to the anode side of the membrane electrode assembly (MEA). At the anode side it is catalytically split into protons and electrons. (http://en.wikipedia.org/wiki/Proton_exchange_membrane_fuel_cell, last accessed May 15, 2013) This oxidation half-cell reaction or Hydrogen Oxidation Reaction (HOR) is represented by:

### At the Anode:

H₂ [symbol] 2H⁺+2e⁻ E^{o}=0V (1)

The newly formed protons permeate through the polymer electrolyte membrane to the cathode side. The electrons travel along an external load circuit to the cathode side of the MEA, thus creating the current output of the fuel cell. Meanwhile, a stream of oxygen is delivered to the cathode side of the MEA. At the cathode side oxygen molecules react with the protons permeating through the polymer electrolyte membrane and the electrons arriving through the external circuit to form water molecules. This reduction half-cell reaction or oxygen reduction reaction (ORR) is represented by:

### At the Cathode:

½O₂+2H⁺+2e⁻ [symbol] H₂O E^{o}=1.229V (2)

Overall reaction:

H₂+½O₂ [symbol] H₂O E^{o}=1.229V (3)

The reversible reaction is expressed in the equation and shows the reincorporation of the hydrogen protons and electrons together with the oxygen molecule and the formation of one water molecule.

In fuel cells, the ORR kinetics is very slow. In order to speed up the ORR kinetics to reach a practical usable level in a fuel cell, a cathode ORR catalyst is needed. The catalysts developed so far in acid fuel cells have a high amount of Platinum Group Metals (PGMs, iridium, osmium, palladium, platinum, rhodium, and ruthenium). However, these catalysts may not have enough activity per mass of PGM and may have less durability than desired. This, as well as the high cost, limits the broad commercialization of fuel cell cars.

Pt-based core-shell nanocatalysts developed by either placing Pt monolayer (PtML) on Pd or PdAu alloy cores [K. Sasaki, H. Naohara, Y M. Choi, Yun Cai, W-Fu Chen, P. Liu, R. R. Adzic, Nat. Commun. 2012; 3, 1115. Incorporated herein in its entirety by reference] or utilizing the Pt skin formed on PtM alloy particles, where M is an activity-enhancing metal, such as Ni, Co, and Fe [M. Watanabe, H. Yano, D. A. Tryk, H. Uchida, J. Electrochem. Soc. 2016, 163, F455-F463. Incorporated herein in its entirety by reference]. The enhanced PGM mass activity results from favorable surface catalytic properties induced by the core metals. In addition, core metal induced lattice contraction enhances the dissolution resistance of Pt.

However, the activity-promoting core metals may be more prone to dissolution than Pt and pinhole-free Pt shells may be challenging to make in large scale catalyst manufacturing facilities. Thus, core metal dissolution, including Pd that is much more stable than Ni, Co, and Fe, were found by the durability tests with potential cycles, especially by those up to 1.4 or 1.5 V. Acid-stable core materials are sought for, such as, niobium oxides [K. Sasaki, L. Zhang, R. R. Adzic, Phys. Chem. Chem. Phys. 2008, 10, 159-167. Incorporated herein in its entirety by reference]. However, below-10-nm niobium oxide particles with a Pt monolayer spread on oxide surfaces may be challenging to obtain.

Disclosed herein is a catalyst that uses a corrosion resistant refractory metal, like tungsten (W), Rhenium (Re), or Molybdenum (Mo), to reduce the amount of Pd in Pt/Pd-type core-shell nanocatalysts on carbon support. Thus, the durability of the catalyst (Pt/Pd/W) may be improved while simultaneously enhancing PGM activity due to reduced amount of PGM.

The various embodiments of the invention facilitate synthesis of low cost, highly active and very stable electrocatalysts for ORR. Disclosed are PtML core-shell catalysts which use cores of refractory metals (W, Mo, or Re) and/or their alloys with iron group metals like Nickel (Ni) iron (Fe) or cobalt (Co). That way, total PGM loading in PtML core-shell catalysts can be reduced and durability improved since refractory metals and their alloys provide high corrosion stability at fuel cell operating conditions.

Core particles may be formed by any suitable method of forming core particles. For example the methods of forming core nanoparticles described in U.S. Patent Publication Nos. 201/00197490 A1, 2010/0216632 A1, 2011/0155579 A1, and in U.S. Pat. Nos. 7,691,780 B2, 7,704,918 B2, 7,855,021 B2, and 9,716,279 B2 all incorporated herein by reference in their entirety, may be used. Furthermore, core nanoparticles may be formed as described in U.S. patent application Ser. No. 13/860,316, filed Apr. 10, 2013, titled Synthesis of Nanoparticles Using Ethanol, U.S. Publication No. 2013/0264198, the contents of which is incorporated herein in its entirety.

The core particles may, for example, be formed by reducing metal salt solutions of the refractory metals (W, Mo, or Re) and/or iron group metals (Ni, Fe, or Co). In other words, the core may be a binary allow of the refractory metal and the iron group metal. Any suitable metal salt solutions may be used. The metal salts may be chlorides; carbonates, acetates, citrates, fluorides, nitrates, nitrites, phosphates, sulfates, or combinations thereof, of the metal ions. The metal salt solutions may also include a surfactant.

In an embodiment, the particle core includes one metal selected from W, Mo, and Re, and one metal selected from Ni, Fe, and Co combined to create a binary alloy core. The binary particle core may include the following combinations of metals: WNi, WFe, WCo, MoNi, MoFe, MoCo, ReNi, ReFe, and ReCo.

The binary cores listed above are preferred. However, one or more additional metals from the refractory metals (W, Mo, or Re) and the iron group metals (Ni, Fe, or Co) may be combined with the metals combinations above to create a ternary or quaternary core.

The “particle core” is referred to herein interchangeably with the “core” and the “metal alloy core”.

In certain embodiments the core particle includes Ni and W.

The ratio of refractory metal (W, Mo, or Re) to iron group metal (Ni, Fe, or Co) may be about 1:1 to about 1:2. Preferably, the ratio is closer to about 1:1.

The metal alloy core may be in a homogeneous form. In a homogeneous form, the metal atoms in the metal alloy core are distributed uniformly on the molecular level throughout the core. In a preferred embodiment, the core is in homogeneous form.

The metal alloy core may be in a heterogeneous form. In a heterogeneous form, the metal atoms in the metal alloy core are distributed with various composition, i.e., non-uniformly, in the core. For example, a heterogeneous metal alloy core can include individual grains, regions, or crystallites composed of one metal intermingled with individual grains, regions, or crystallites of another metal throughout the core.

The particles disclosed and described in this specification are not limited to any particular shape or size, but in some embodiments may be nanoparticles with sizes ranging from 1 to 100 nm in one or more dimensions. For example, the size of the nanoparticles may be any of the following values combined to form minima, maxima, or a range: 1 nm, 2 nm, 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, and 100 nm. In an embodiment, the size of the nanoparticles ranges from about 1 nm to about 10 nm. In another preferred embodiment, the size of the nanoparticles ranges from about 3 nm to about 10 nm. In yet another embodiment, the particle core is a nanoparticle having dimensions ranging from about 2 nm to about 5 nm along three orthogonal directions (dimensions).

The shape may be spherical or spheroidal, but again is not so limited. Throughout this specification, the particles will be primarily disclosed and described as essentially spherical nanoparticles. It is to be understood, however, that the particles may take on any shape, size, and structure as is well-known in the art. This includes, but is not limited to branching, conical, pyramidal, cubical, mesh, fiber, cuboctahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size are preferably configured so that the bonding configuration of surface atoms is such that their reactivity and, hence, their ability to function as a catalyst is increased. For example, nanorods or nanowires may have a thickness (diameter) of about 2 nm to 5 nm while their length may be up to about 100 nm.

The core may be bound to an electrically conductive support. Preferably, the electrically conductive support is carbon-based. Some examples of carbon-based electrically conductive supports include carbon black, graphitized carbon, graphite, and activated carbon. The electrically conductive support material is preferably finely divided.

In a preferred embodiment, the core is directly adhered to a carbon surface.

A Pd layer may be deposited onto the particle core using any of a wide variety of thin film deposition processes which are well-known in the art. In one embodiment, the galvanic displacement of a layer of core particle atoms by the more noble metal Pd is performed, resulting in the conformal deposition of a monolayer of Pd metal on the particle core.

A catalytically active surface layer (such as Pt) may also be deposited on to the particle core using any of a wide variety of thin film deposition processes which are well-known in the art.

For example the Pd layer and the catalytically active surface layer may be deposited as described in U.S. Pat. No. 9,550,170 B2 and in U.S. Pat. No. 9,716,279 B2, all incorporated herein by reference in their entirety.

A synthetic procedure which employs the principles of electrodeposition and galvanic displacement has been utilized by Brankovic, et al. (hereinafter “Brankovic”) to deposit a monolayer of Pt onto Au(111) substrates and by Adzic, et al. (hereinafter “Adzic”) to deposit Pt monolayers onto Pd(111) and carbon-supported Pd nanoparticles. This procedure is described, for example, in “Metal Monolayer Deposition By Replacement Of Metal Adlayers On Electrode Surfaces,” Surf. Sci., 474, L173 (2001) and U.S. Pat. No. 7,691,780, respectively. This process has also been described in detail by J. Zhang, et al. in “Platinum Monolayer Electrocatalysts for 02 Reduction: Pt Monolayer On Pd(111) And On Carbon-Supported Pd Nanoparticles,” J. Phys. Chem. B 108, 10955 (2004). Each of the aforementioned references is incorporated by reference as if fully set forth in this specification.

The deposition process is a series of electrochemical reactions which, when performed sequentially result in a film with the targeted coverage and composition. The procedure involves the initial formation of an adlayer of a metal onto a substrate by underpotential deposition (UPD). This is followed by the galvanic displacement of the adlayer by a more noble metal, resulting in the conformal deposition of a monolayer of the more noble metal on the substrate. The overall process includes the irreversible and spontaneous redox displacement of an adlayer of a non-noble metal by a more noble metal. This enables the controlled deposition of a thin, continuous layer of a desired metal. In the UPD process, the substrate metal is more noble than the metal undergoing deposition in order to avoid becoming oxidized.

Although the catalytically active surface layer is not limited to any particular material, it is preferably Pt due to its excellent catalytic properties. Consequently, an example in which a monolayer of Pt is formed on nanoparticles using the processes described by Brankovic and Adzic will now be described in detail. It is to be understood, however, that the process is not limited to Pt and other noble metals may be utilized. The method involves the initial formation of a monolayer of a metal such as copper (Cu) by underpotential deposition (UPD) in a solution comprised of 50 mM CuSO₄ and a 50 mM H₂SO₄ solution. The Cu-coated nanoparticles are then immersed from solution and rinsed with deionized water to remove Cu²⁺ ions from the surface. This is followed by immersion in a solution comprised of 1.0 mM K₂PtCl₄ and 50 mM H₂SO₄ under a N₂ atmosphere for approximately two minutes to replace all Cu atoms with Pt atoms. The Pt-coated nanoparticle substrate is again rinsed with deionized water. The above processes are carried out in a multi-compartment cell under a N₂ atmosphere in order to prevent Cu oxidation by O₂ during sample transfer.

The galvanic, displacement (redox reaction) can be described by the following equation

M_{UPD}⁰+(m/z)L^{z+}⇒M^{m+}+(m/z)L⁰ (1)

where M_{UPD}⁰ represents a UPD metal adatom on the electrode surface and L^{z+} is a noble metal cation with positive charge z+ and valence z. The M^{m+} represents the metal cation in the solution obtained after the UPD adatom was oxidized, and L⁰ is a noble atom deposited in the redox process. The above process results in the conformal deposition of a monolayer of Pt on high-surface-area core particles. The deposition cycle comprising UPD of Cu followed by galvanic displacement with Pt may be repeated as needed to produce two or more layers of Pt in order to ensure complete coverage of the nanoparticle surface. Conversely, the UPD of Cu may be controllably limited such that submonolayer coverages of Cu and, hence, Pt are obtained. Deposition of an initial adlayer by UPD may also be accomplished using metals other than Cu such as, for example, lead (Pb), bismuth (Bi), tin (Sn), cadmium (Cd), silver (Ag), antimony (Sb), and thallium (Tl). The choice of metal used for UPD will influence the final Pt surface coverage obtained for a given UPD adlayer. This occurs due to variations in the size and valency among the different metals. The metal overlayer used is not limited to Pt, but may be formed from other noble metals as long as the desired metal is more noble than the UPD adlayer. This may be accomplished by contacting the copper-coated particles with their corresponding solutions. For example, monolayers of iridium (Ir), ruthenium (Ru), osmium (Os), and rhenium (Rh) can be deposited by displacement of a. ML of a less noble metal such as Cu using IrCl₃, RuCl₃, OsCl₃, or ReCl₃, respectively. Furthermore, the metal overlayer may be formed as an alloy with any number of constituents such as binary, ternary, quaternary, or quinary alloys with experimentally optimized stoichiometry ratios.

The process offers unprecedented control over film growth and is advantageous in terms of its versatility, reproducibility, and efficient utilization of source material. Since a costly precious metal such as Pt can be utilized as a thin film instead of in bulk form, significant cost savings can be attained. The utilization of a noble metal/substrate nanoparticle may also provide unexpectedly heightened catalytic activity due to synergistic effects between the nanoparticles and the catalytic overlayer. The unexpected increase in catalytic activity may arise due to electronic and geometric effects which arise from the formation of surface metal-metal bonds and the differing lattice constants of the catalytic overlayer and underlying substrate.

The thickness of the layer of catalytically active metal, Pt, is any of the following values to form a minim or a maxima or a combination of the following values to form a range: 1 monolayer, 2 monolayers, 3 monolayers, 4 monolayers, 5 monolayers, and 6 monolayers.

Preferably, the layer of the catalytically active metal, Pt, is from about 1 to about 4 monolayers thick.

The thickness of the layer of Pd is any of the following values to form a minima or a maxima or a combination of the following values to form a range: 1 monolayer, 2 monolayers, 3 monolayers, 4 monolayers, 5 monolayers, and 6 monolayers.

Preferably, the layer of Pd is from about 1 to about 4 monolayers thick.

Preferably, the layer of Pt adhered to the layer of Pd is not adhered in-between the particle cores and carbon surface.

Another aspect of the invention relates to a fuel cell. The full cell utilizes the electrocatalyst described above as the oxygen-reducing cathode, and further includes an anode, an electrically conductive contact connecting the cathode to the anode, and an ion-conducting electrolyte in mutual contact with the cathode and the anode.

In another aspect of the invention, a method for producing electrical energy is described. The method includes providing a fuel cell as described above, contacting the cathode with oxygen, and contacting the anode with a fuel source.

### Example

In an example, the preparation of a PtML/Pd/WNi catalyst is as following: A 1000 mg of block polymer (poly(ethylene glycol)-block-poly(propylene glycol)-block-poly(ethylene glycol)) was pre-dissolved in 15 mL tetrahydrofuran (THF). Then, 0.25 mmol (89.98 mg) of tungsten hexacarbonyl (W(CO)₆) and 0.25 mmol (64.23 mg) of nickel(II) acetylacetonate (Ni(acac)₂) were added to the THF with block polymer solution. Next, 154.46 mg of Vulcan XC-72R carbon black was added to the solution in order to achieve 28.2 wt % of metal loading. The mixture was purged with Ar and ultrasonicated with a sonication rod for 10 min before adding 2 mL of 1 M super-hydride (Li(C₂H₅)₃BH) solution (THF as solvent). Following this, solution was ultrasonicated for 4 h. The procedure was carried out in a three-neck flask which was immersed in ice bath during the whole process to keep the temperature constant and prevent overheating and drying of the solvent (THF). After that, the mixture was centrifuged at 9000 rpm for 30 min and then precipitate was dried under vacuum.

The dried solids were then thermally treated in pure hydrogen (H₂) at 250° C. for 2 h to remove all the residual block polymers. Then 100 mg of WNi/C powder was dispersed into 10 mL of 0.03 M palladium(II) nitrate Pd(NO₃)₂ aqueous solutions in order to displace the surface layers of WNi with Pd. The Pd/WNi/C nanoparticles were washed with 2 L of deionizing water and dried in vacuum oven overnight.

Pt monolayer was deposited onto Pd/WNi/C nanoparticles using method for controllable synthesis of Pt monolayer electrocatalysts. This method involves the redox displacement of an adlayer of less-noble metal such as Cu by a Pt monolayer J. Zhang, Y. Mo, M. B. Vukmirovic, R. Klie, K. Sasaki, R. R. Adzic, J. Phys. Chem. B 2004, 108, 10955-10964. J. Zhang, F. H. B. Lima, M. H. Shao, K. Sasaki, J. X. Wang, J. Hanson, R. R. Adzic, J. Phys. Chem. B 2005, 109, 22701-22704. M. B. Vukmirovic, S. T. Bliznakov, K. Sasaki, J. X. Wang, R. R. Adzic, Electrochem. Soc. Interface 2011, 20 (Summer), 33-40. All incorporated herein in their entirety by reference]. A Cu monolayer is deposited by the underpotential deposition (UPD) on supporting nanoparticles (Pd, or other metal more noble than Cu, or the UPD metal). Upon deposition of a uniform Cu monolayer, the solution is replaced by one containing Pt ions. In galvanic displacement, Cu is oxidized and Pt monolayer gets deposited on Pd. More specifically, 2 mg of Pd/WNi/C nanoparticles were dispersed in 1 mL of solution consisting of water (H₂O) and isopropanol alcohol (IPA). (H₂O:IPA=3:1) in which 0.5 μL of nafion (5 wt % water solution) was added, and sonicated till uniform ink was form. Then, 10 μL of the ink was placed onto glassy carbon electrode. PtML was deposited by the procedure described above.

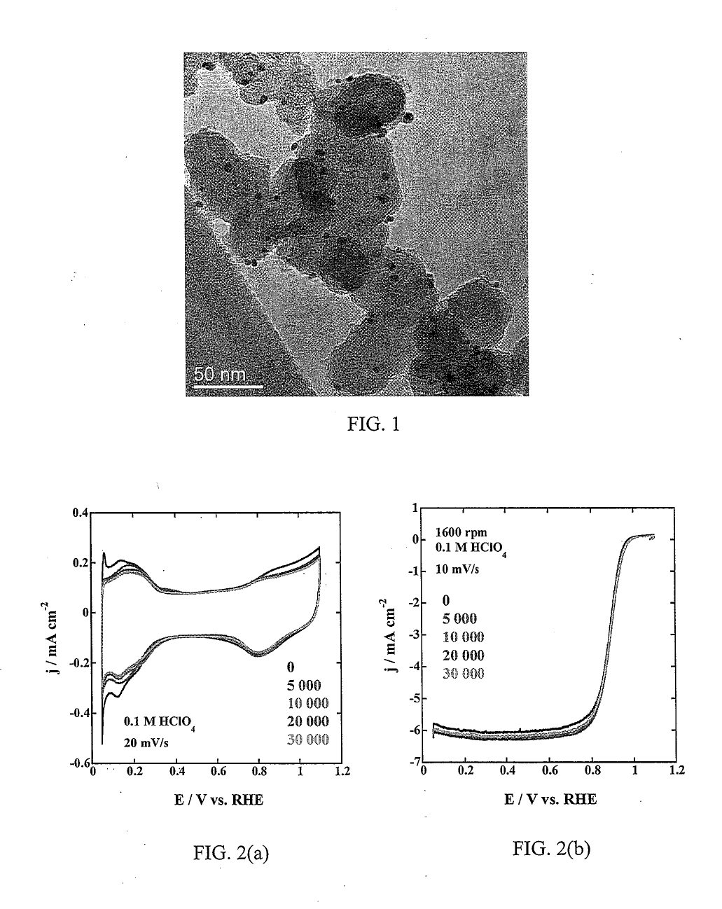

The dispersion and particle size of WNi nanoparticles were characterized by transmission electron microscope (TEM). FIG. 1 shows the TEM images of WNi nanoparticles. The most metal particles are ˜5 nm in size with narrow dispersion. Also, small number of WNi nanoparticles indicates low metal loading.

The PtML/Pd/WNi/C catalysts' activity and durability were examined using rotating disk electrode in 0.1 M HClO₄. Durability test consist of cycling the potential of the electrode coated with PtML/Pd/WNi/C catalysts between 0.6 and 0.9 V (vs. reversible hydrogen electrode (RHE)) with scan rate of 50 mV/s. FIG. 2 shows the cyclic voltammetry and ORR polarizations curves for PtML/Pd/WNi/C samples recorded after 0; 5,000; 10,000; 20,000; and 30,000 cycles of the durability test. Therefore, FIG. 2 shows the change of electrochemical area, determined by hydrogen desorption charge, onset potential, and half-wave potential during durability test. It can be noticed that there is not much of a change in electrochemical area, while change in onset and half-wave potential is only a few mV. This is an indication of an excellent durability.

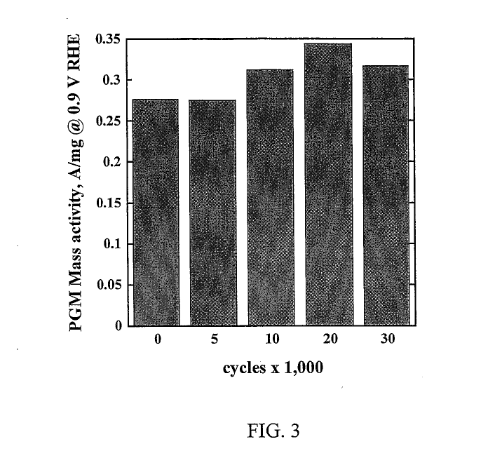

The change of PGM mass activity of PtML/Pd/WNi/C catalyst during the durability test is shown in Figure. 3. The value is slightly below DOE 2020 target of 0.44 A/mg. This is due to low metal loading indicated by TEM images, FIG. 1.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are incorporated by reference as if fully set forth in this specification.

1. An electrocatalyst comprising:
a particle core comprising at least one metal selected from W, Mo, and Re, and at least one metal selected from Ni, Fe, and Co;
a layer of Pd adhered to the core; and
a layer of catalytically active metal adhered to the layer of Pd.

2. The electrocatalyst of claim 1, wherein the particle core consists of one metal selected from W, Mo, and Re and one metal selected from Ni, Fe, and Co.

3. The electrocatalyst of claim 1, wherein the ratio of one metal selected from W, Mo, and Re to one metal selected from Ni, Fe, and Co is about 1:1 to about 1:2.

4. The electrocatalyst of claim 1, wherein the particle core comprises W and Ni.

5. The electrocatalyst of claim 1, wherein the layer of Pd is from about 1 to about 4 atom monolayers thick.

6. The electrocatalyst of claim 1, wherein the thin layer of catalytically active metal atoms comprises Pt.

7. The electrocatalyst of claim 6, wherein the Pt is from about 1 to about 4 atom monolayers thick.

8. The electrocatalyst of claim 1, wherein the particle core is a nanoparticle having dimensions of about 1 nm to about 100 nm along three orthogonal directions.

9. The electrocatalyst of claim 1, wherein the particle core is a nanoparticle having dimensions of about 2 nm to about 5 nm along three orthogonal directions.

10. The electrocatalyst of claim 1, wherein the core comprises W and Ni, and the catalytically active metal comprises Pt.

11. The electrocatalyst of claim 1, wherein the particle core is directly adhered to a carbon surface.

12. The electrocatalyst of claim 1, wherein the layer of catalytically active metal adhered to the layer of Pd is not adhered in-between the particle cores and carbon surface.

13. A fuel cell comprising:
(i) an cathode comprised of a particle core comprising at least one metal selected from the group consisting of W, Mo, and Re, and least one metal selected from the group consisting of Ni, Fe, and Co; a layer of Pd adhered to the core; and a layer of Pt adhered to the layer of Pd, wherein the particle core is directly adhered to a carbon surface;
(ii) an anode;
(iii) an electrically conductive contact connecting the cathode to the anode; and
(iv) an ion-conducting electrolyte in contact with the cathode and the anode.

14. The fuel cell of claim 13, wherein the particle core consists of one metal selected from W, Mo, and Re and one metal selected from Ni, Fe, and Co.

15. The fuel cell of claim 14, wherein the particle core comprises W and Ni.

16. The fuel cell of claim 13, wherein the layer of Pd is from about 1 to about 4 atom monolayers thick and the layer of Pt is from about 1 to about 4 atom monolayers thick.

17. The fuel cell of claim 13, wherein the particle core is a nanoparticle having dimensions of about 2 nm to about 5 nm along three orthogonal directions.

18. The fuel cell of claim 13, wherein the layer of catalytically active metal adhered to the layer of Pd is not adhered in-between the particle cores and carbon surface.

19. A method for producing electrical energy, the method comprising:
(a) providing a fuel cell comprising:
(i) an cathode comprised of a particle core comprising at least one metal selected from the group consisting of W, Mo, and Re, and least one metal selected from the group consisting of Ni, Fe, and Co; a layer of Pd adhered to the core; and a layer of Pt adhered to the layer of Pd, wherein the particle core is directly adhered to a carbon surface;
(ii) an anode;
(iii) an electrically conductive contact connecting the cathode to the anode; and
(iv) an ion-conducting electrolyte in mutual contact with the cathode and the anode.
(b) contacting the cathode with oxygen; and
(c) contacting the anode with a fuel source.

20. The method of claim 19, wherein the particle core comprises W and Ni.
